(19) United States
(12) Patent Application Publication
(10) Pub. No.: US 2025/0190515 A1
(43) Pub. Date: Jun. 12, 2025

(54) PARAMETER SEARCH APPARATUS, PARAMETER SEARCH METHOD AND STORAGE MEDIUM

(71) Applicant: KABUSHIKI KAISHA TOSHIBA, Tokyo (JP)

(72) Inventors: Hironari KAMADA, Kawasaki Kanagawa (JP); Hideyuki NAKAGAWA, Kawasaki Kanagawa (JP); Yasunori TAGUCHI, Kawasaki Kanagawa (JP); Shinya HIGASHI, Yokohama Kanagawa (JP); Kuniaki YAMAMOTO, Yokohama Kanagawa (JP)

(73) Assignee: KABUSHIKI KAISHA TOSHIBA, Tokyo (JP)

(21) Appl. No.: 18/780,686

(22) Filed: Jul. 23, 2024

(30) Foreign Application Priority Data
Dec. 8, 2023 (JP) 2023-207772

(51) Int. Cl. G06F 17/11

(52) U.S. Cl. CPC G06F 17/11

(57) ABSTRACT

An apparatus sets an objective function based on a first function evaluating a parameter value based on a performance value and a second function evaluating a parameter value based on a target parameter. The apparatus calculates an objective function value by applying to the objective function a performance value corresponding to a parameter value to be evaluated and/or the performance value. The apparatus constructs a model representing the objective function based on the parameter value and the objective function value stored in a memory and determines a parameter value to be evaluated next based on the model. The apparatus selects a parameter value satisfying a criterion based on the target performance and the target parameter from the parameter value stored in a memory.

### CROSS-REFERENCE TO RELATED APPLICATION

This application is based upon and claims the benefit of priority from prior Japanese Patent Application No. 2023-207772, filed Dec. 8, 2023, the entire contents of which are incorporated herein by reference.

### FIELD

Embodiments described herein relate generally to a parameter search apparatus, a parameter search method and a storage medium.

### BACKGROUND

In manufacturing a product by a manufacturing device, manufacturing parameters such as temperature, pressure and processing time need to be set for the manufacturing device, which affects the quality of the product. To manufacture products of stable quality, parameter values need to be appropriately adjusted. The parameter values are often adjusted by technicians based on their experience and intuition. In recent years, however, in order to eliminate personalization and improve the efficiency of adjustment, optimization algorithms such as Bayesian optimization are sometimes used to determine the parameter values of the manufacturing device. The following descriptions will be given on the assumption that quality can be ensured if the performance meets certain standards. If, however, the quality can be ensured, its index is not limited to the performance.

In a typical optimization algorithm, a search area is searched for a single point at which a function value is the best. If, however, there are a plurality of solution candidates whose objective function values (indicators related to the performance of a product) satisfy the performance specifications (performance target values with margins), there is a requirement that a manufacturing parameter having excellent manufacturing efficiency (manufacturing time, power consumption, etc.) be selected.

In the penalty function method, a constraint expression for optimization is incorporated into an objective function and solved as an unconstrained optimization problem. If, in this method, the performance of a product is applied to the original objective function and the efficiency of manufacturing is applied to the constraint term to perform optimization, parameter values in which both the performance and efficiency are reasonably high can be obtained. In this method, however, the objective function itself is changed by the constraint term. If, therefore, a point with the best objective function value is selected, there is a possibility that the performance specifications will not be satisfied. In addition, if an optimization method using a model such as Bayesian optimization is used as the optimization algorithm, an objective function including the constraint term is modeled. It is thus impossible to refer to the performance of a product or a model of the function related to the performance alone.

### BRIEF DESCRIPTION OF THE DRAWINGS

FIG. 1 is a block diagram showing an example of a functional configuration of a parameter adjustment system.

FIG. 2 is a table showing an example of combinations of objective function values and parameter values stored in a first storage unit.

FIG. 3 is a diagram showing the relationship between input and output of a first model.

FIG. 4 is a table showing an example of a combination of performance values and parameter values stored in a second storage unit.

FIG. 5 is a flowchart showing an example of a parameter search process to be performed by a parameter search apparatus.

FIG. 6 is a diagram schematically showing an example of output parameter selection made by a selection unit.

FIG. 7 is a table showing parameter search results of a first comparative example, a second comparative example and the present embodiment.

FIG. 8 is a block diagram showing an example of a functional configuration of a parameter adjustment system according to an application example.

FIG. 9 is a diagram showing the relationship between input and output of a second model.

FIG. 10 is a block diagram showing an example of a hardware configuration of a parameter search apparatus.

### DETAILED DESCRIPTION

A parameter search apparatus according to an embodiment comprises a first setting unit which sets a target parameter representing a target of a parameter value; a second setting unit which sets target performance representing a target of a performance value; a third setting unit which sets an objective function based on a first function that evaluates the parameter value based on the performance value and a second function that evaluates the parameter value based on the target parameter; a calculation unit which calculates a first objective function value by applying to the objective function a first performance value corresponding to a first parameter value to be evaluated or both the first parameter value and the first performance value; a first storage unit which stores the first objective function value in association with the first parameter value; a second storage unit which stores the first performance value in association with the first parameter value; a search unit which constructs a first model representing the objective function based on a combination of the first parameter value and the first objective function value which are stored in the first storage unit and determines a first parameter value to be evaluated next based on the first model; and a selection unit which selects a first parameter value that satisfies a selection criterion based on the target performance and the target parameter from the first parameter value stored in the second storage unit.

A parameter search apparatus, a method and a storage medium according to an embodiment will be described below with reference to the drawings.

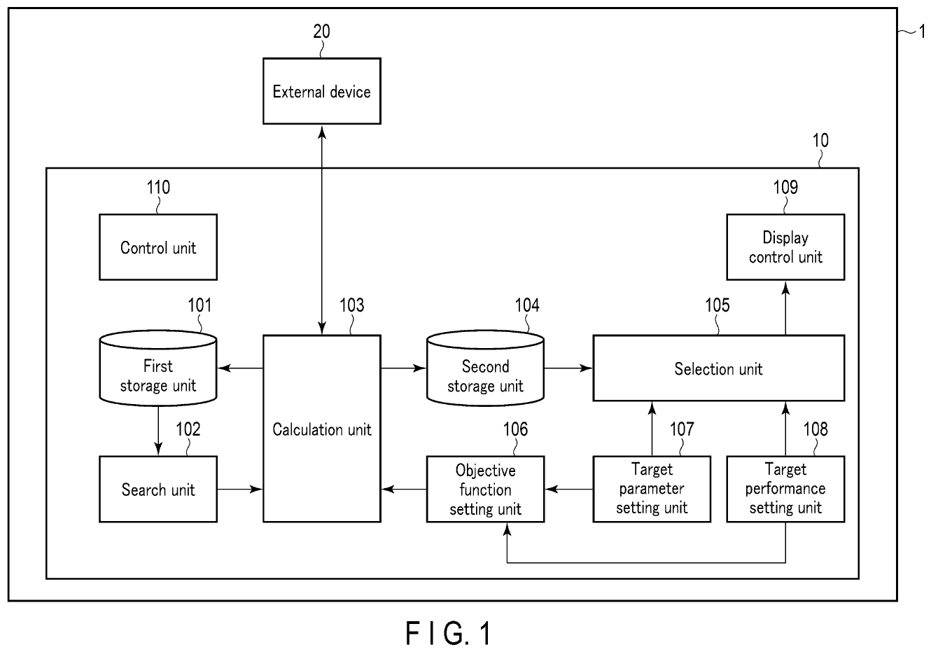

FIG. 1 is a block diagram showing an example of a functional configuration of a parameter adjustment system 1 according to the embodiment. As shown in FIG. 1, the parameter adjustment system 1 is a computer system including a parameter search apparatus 10 and an external device 20. The parameter search apparatus 10 and the external device 20 are communicatively connected to each other by wire or radio. The parameter search apparatus 10 is a computer that searches for an optimum parameter value. The parameter search apparatus 10 supplies a parameter value to the external device 20. The external device 20 is a computer that outputs a performance value corresponding to the parameter value. Specifically, the external device 20 receives a parameter value from the parameter search apparatus 10 and outputs a performance value that is a value obtained by evaluating the results of a simulation or an experiment performed based on the received parameter value. The performance value is supplied to the parameter search apparatus 10. Since the parameter search apparatus 10 has only to be able to acquire the performance value output by the external device 20, the parameter search apparatus 10 and the external device 20 need not be connected by wire or radio.

As shown in FIG. 1, the parameter search apparatus 10 includes a first storage unit 101, a search unit 102, a calculation unit 103, a second storage unit 104, a selection unit 105, an objective function setting unit 106, a target parameter setting unit 107, a target performance setting unit 108, a display control unit 109 and a control unit 110.

The first storage unit 101 stores a combination of a parameter value acquired from the calculation unit 103 and an objective function value. The parameter value is not particularly limited but, as an example, a manufacturing parameter value, such as set temperature, set pressure and processing time of a manufacturing device is assumed. The objective function value is the value of an objective function calculated by the calculation unit 103 based on the parameter value.

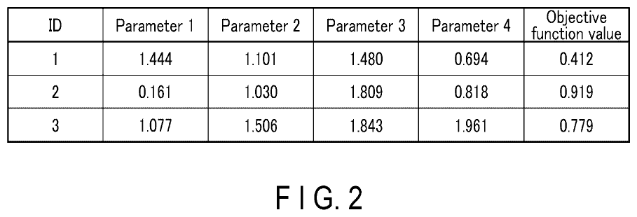

FIG. 2 is a table showing an example of combinations of objective function values and parameter values stored in the first storage unit 101. There is one or more parameter values corresponding to one ID. In the example of FIG. 2, there are four parameter values 1 to 4. For example, there are four different parameter values to be set for a manufacturing device, that is, set temperature, set pressure, set humidity and processing time, and a combination of these four different parameter values is associated with one ID. Each of the parameter values may be expressed as either a continuous value or a discrete value or a categorical variable. One objective function value is associated with a combination of four different parameter values corresponding to the one ID.

The search unit 102 constructs a first model representing an objective function based on the objective function values and the parameter values stored in the first storage unit 101 to determine a parameter value to be evaluated next based on the first model. As the parameter value to be evaluated next, a parameter value that has a high probability of the minimum or maximum objective function is searched. Although the maximum objective function will be described in this embodiment, the objective function may be minimized according to problem setting. The first model represents the relationship between parameter values and objective function values. The next parameter value to be evaluated next is input to the external device 20 by the calculation unit 103 to perform simulation or experiment.

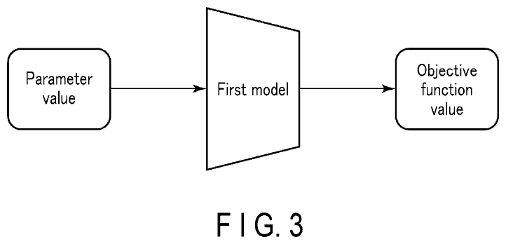

FIG. 3 is a diagram the relationship between input and output of the first model. The search unit 102 uses the combination of the parameter values stored in the first storage unit 101 and their corresponding objective function values as training data to train the first model based on a training method such as Gaussian process regression, a random forest and a neural network. The first model is thus constructed with the parameter values as inputs and the objective function values as outputs.

The calculation unit 103 calculates an objective function value by applying the performance value corresponding to a parameter value to be evaluated or both of a parameter value to be evaluated and a performance value corresponding to the parameter value to the objective function set by the objective function setting unit 106. Specifically, the calculation unit 103 supplies a parameter value to be observed next to the external device 20. The external device 20 outputs observation values that are results of simulation and/or experiment of the parameter value. The calculation unit 103 acquires the observation values from the external device 20. Assume that the observation values are values representing the performance of a product (performance values). The calculation unit 103 transmits the combination of the parameter values and the objective function values to the first storage unit 101 and transmits the combination of the parameter values and the performance values to the second storage unit 104.

The second storage unit 104 stores the combination of the parameter values and performance values acquired from the calculation unit 103.

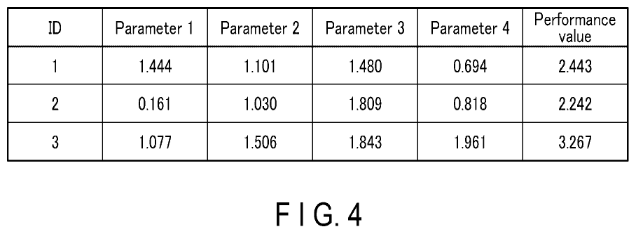

FIG. 4 is a table showing an example of the combination of the parameter values and performance values stored in the second storage unit. The IDs shown in FIGS. 2 and 4 are linked to each other. If both the IDs are the same, the parameter values shown in FIG. 4 are the same as those shown in FIG. 2. One performance value is associated with a combination of four different parameter values related to one ID. The performance value is a value obtained by evaluating the performance achieved by the combination of four different parameter values related to one ID. Note that a plurality of performance values may be associated with the combination of the parameter values.

The selection unit 105 selects a parameter value that satisfies selection criteria based on the target performance and the target parameter from the combination of the parameter values and performance values stored in the second storage unit 104. The selected parameter value is output. As an example of the parameter value that satisfies the selection criteria, the selection unit 105 selects a parameter value closest to the target parameter among the parameter values whose performance values satisfy the target performance.

The objective function setting unit 106 sets an objective function based on a first function for evaluating a parameter value based on the performance value and a second function for evaluating a parameter value based on the target parameter. The first function is, for example, a function for evaluating a parameter value higher as the performance value is higher, and is defined based on one or more performance values. The second function is, for example, a function for evaluating a distance between the parameter value and the target parameter. The second function may be a function that gives a larger penalty as the parameter value is further from the target parameter. For example, the objective function is defined by the sum of a first function and a second function with a weighting factor. Note that the design of the first function is not limited to the above and the first function, for example, may be so designed that the parameter value increases with decrease in the performance value. In addition, the design of the second function is not limited to the above and the second function may be, for example, a function for evaluating the degree of similarity between the parameter value and the target parameter or other measures.

The target parameter setting unit 107 sets a target parameter. The target parameter may be given by a scalar value, a range, a function, and the like. Specifically, the range means a value between the upper and lower limit values. The target parameter is referred to, for example, by the objective function setting unit 106 for setting an objective function and by the selection unit 105 for selecting a parameter value.

The target performance setting unit 108 sets target performance. The target performance is given by a scalar value, a range, a function, and the like. Specifically, the range means a value between the upper and lower limit values. The target performance means performance specifications. The target performance is referred to, for example, by the objective function setting unit 106 for creating an objective function and by the selection unit 105 for selecting a parameter value.

The display control unit 109 displays a variety of items of information on a display device. For example, the display control unit 109 may display the parameter values selected by the selection unit 105 on the display device. As another example, the display control unit 109 may graphically display the relationship between the parameter values and the performance values.

The control unit 110 comprehensively controls the parameter search apparatus 10. Specifically, the control unit 110 repeats controlling the search unit 102 to construct a first model, controlling the search unit 102 to determine the next parameter value, controlling the calculation unit 103 to acquire a performance value and calculate an objective function value, controlling the second storage unit 104 to store the combination of the parameter value and the performance value, and controlling the first storage unit 101 to store the combination of the parameter value and the objective function value until the process end conditions are satisfied. The control unit 110 may control setting to be made by the objective function setting unit 106.

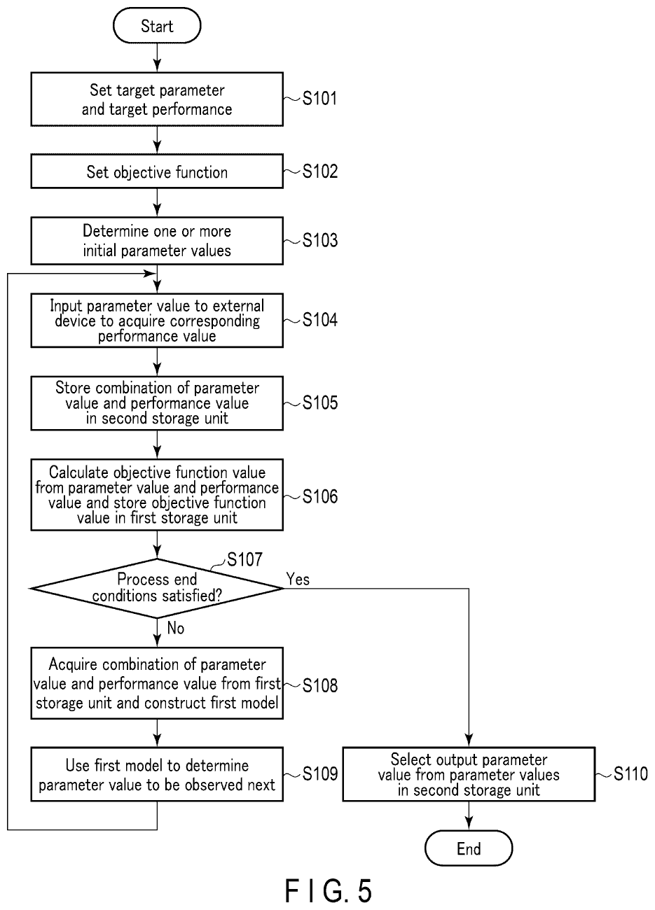

FIG. 5 is a flowchart showing an example of a parameter search process to be performed by the parameter search apparatus 10 according to the embodiment. As shown in FIG. 5, first, the target parameter setting unit 107 sets a target parameter and the target performance setting unit 108 sets target performance (step S101). The target parameter may be a set of scalar values the number of which is equal to that of parameters to be searched by the parameter search apparatus 10 or a fixed range or function. For example, a parameter value that results in the lowest manufacturing cost may be set as the target parameter or a range of parameter values that results in a manufacturing cost within an acceptable range may be set. The target performance setting unit 108 also sets performance specifications to be satisfied, which are related to the performance value of a product, as the target performance. The target performance may be a scalar value or a fixed range. The target performance may also be a single performance value or a plurality of performance values. The target parameter and the target performance may be set according to a user's instruction or according to an optional algorithm.

If step S101 is executed, the objective function setting unit 106 sets an objective function for parameter optimization (step S102). In step S102, the objective function setting unit 106 acquires the target parameter and target performance set in step S101 to set an objective function based on the target parameter and target performance. The objective function setting unit 106 sets the form, coefficient, etc. of the objective function according to the user's instruction.

As an example, objective function f′(x) is expressed by the following equation (1).

$${f}^{′} ( x ) = f ( x ) + w \times g ( x ) \qquad ( 1 )$$

The first function f(x) of the objective function is a function of evaluating a parameter value x based on the performance value that is a response of the external device 20 to the parameter value x. As the parameter x, for example, a vector value of a plurality of dimensions such as four dimensions is assumed as illustrated in FIGS. 2 and 4. The first function f(x) may be a function of evaluating the parameter value x higher as the performance value becomes better, such as a squared error or an absolute error between the target performance and the performance value corresponding to the parameter value x. The first function f(x) may be calculated based on one or more performance values. If there are two or more performance values, for example, a function in which a plurality of terms corresponding to the two or more performance values, respectively are added or the like, may be used as the first function.

The second function g(x) of the objective function is a term for evaluating the current parameter value x based on the target parameter. As the second function g(x), a function such that the parameter value x is evaluated higher as the parameter value x is closer to the target parameter, such as the Euclidean distance between the parameter value and the target parameter, that is, a function such that the objective function is penalized as the distance between them is farther.

The coefficient w associated with the second function g(x) is a coefficient that is responsible for the degree of influence of the second term. The smaller the value of the coefficient w, the greater the relative influence of f(x). The larger the value of the coefficient w, the greater the relative influence of g(x). That is, the performance value becomes important as the value of the coefficient w decreases, and the target parameter becomes important as the value of the coefficient w increases.

If step S102 is executed, the calculation unit 103 determines the initial parameter value xᵢₙᵢₜ in order to create initial data for constructing the first model (step S103). The initial parameter value xᵢₙᵢₜ may be determined randomly or specified by the user. In addition, there may be a plurality of elements of the initial parameter value, such as (x¹ᵢₙᵢₜ, x²ᵢₙᵢₜ, . . . ).

If step S103 is executed, the calculation unit 103 supplies the initial parameter value xᵢₙᵢₜ, which is determined in step S103, to the external device 20, and acquires a performance value corresponding to the parameter value that is an output from the external device 20 (step S104). The performance value here may be a single value p or a vector consisting of a plurality of values (p¹, p², . . . ). If a plurality of initial parameter values (x¹ᵢₙᵢₜ, x²ᵢₙᵢₜ, . . . ) are given from step S103, performance values (p¹, p², . . . ) corresponding to all the initial parameter values, respectively are acquired. If the performance value is a vector, ((p¹₁, p¹₂, . . . ), (p²₁, p²₂, . . . ), . . . ) is obtained.

If step S104 is executed, the calculation unit 103 stores in the second storage unit 104 a combination of the initial parameter value xᵢₙᵢₜ determined in step S103 or an observation parameter value xₙₑₓₜ determined in step S109 to be described later and their corresponding performance value p (step S105). The combination of the observation parameter value and the performance value is a combination such as (xᵢₙᵢₜ, p) or (xₙₑₓₜ, p) if the performance value is a single value or (xᵢₙᵢₜ, (p₁, p₂)) or (xₙₑₓₜ, (p₁, p₂)) if the performance value is a plurality of values.

If step S105 is executed, the calculation unit 103 calculates the value f′(xᵢₙᵢₜ) or f′(xₙₑₓₜ) of the objective function set in step S102 from the initial parameter value xₙₑₓₜ or the observation parameter value xₙₑₓₜ and its corresponding performance value p, and stores a combination (xᵢₙᵢₜ, f′(xᵢₙᵢₜ)) of the initial parameter value xᵢₙᵢₜ and the objective function value f′(xᵢₙᵢₜ) or a combination (xₙₑₓₜ, f′(xₙₑₓₜ)) of the observation parameter value xₙₑₓₜ and the objective function value f′(xₙₑₓₜ) in the first storage unit 101 (S106).

If step S106 is executed, the control unit 110 determines whether the process end conditions for optimization are satisfied (step S107). The process end conditions may be determined, for example, according to whether the number of repetitions exceeds a predetermined number or according to whether the elapsed time exceeds a predetermined period of time. It may also be determined according to whether the objective function value f′(x) exceeds a predetermined value. In addition, it may be determined according to whether a predetermined number or more of performance values satisfying the target performance have been collected. Alternatively, a combination of these conditions may be used.

If it is determined that the process end conditions are not satisfied (No in step S107), the search unit 102 acquires a combination (x, f′(x)) of the parameter value and the objective function value from the first storage unit 101 to construct a first model representing the objective function from the acquired combination (step S108). The first model may be constructed by Gaussian process regression, a random forest, a neural network, and the like.

If step S108 is executed, the search unit 102 determines a parameter value xₙₑₓₜ to be observed next, on the basis of the first model constructed in step S108 (step S109). For example, the search unit 102 determines a parameter value, which is likely to maximize the objective function value, as a parameter value xₙₑₓₜ to be observed next. In order to determine the parameter value xₙₑₓₜ, expected improvement (EI) and upper confidential bound (UCB), which are acquisition functions for use in Bayesian optimization, may be used. The EI and UCB are functions represented by the following equations (2) and (3), respectively.

$$EI ( x ) = 𝔼 [ max ( {f}^{′} ( x ) - {f}_{max}^{′} , 0 ) ] \qquad ( 2 )$$

$$or , EI ( x ) = a Φ ( z ) + σ ( x ) ϕ ( z )$$

$$a = μ ( x ) - {f}_{max}^{′} - ξ ,$$

$$z = \frac{a}{σ ( x )}$$

$$UCB ( x ) = μ ( x ) + βσ ( x ) \qquad ( 3 )$$

In the above equations, u is an expected value of the first model and σ is a standard deviation of the first model. In the equation (2), f′ₘₐₓ is the maximum value of the objective function f′ observed so far, Φ is a cumulative distribution function of the normal distribution, φ is a probability density function of the normal distribution, and ξ is a constant for adjustment specified by the user. In the equation (3), β is a user-specified weight indicating how much σ is considered.

If step S109 is executed, a performance value is acquired for the parameter value determined in step S109 (S104), a combination of the parameter value and the performance value is stored (S105), a combination of the parameter value and the objective function value is stored (S106), and the process end conditions are determined (S107). The process of steps S104 to S109 is repeated until the process end conditions are satisfied.

If it is determined in step S107 that the process end conditions are satisfied (Yes in step S107), the selection unit 105 selects an output parameter value (step S110). In step S110, the selection unit 105 first acquires a combination of the parameter value and the performance value from the second storage unit 104. The selection unit 105 selects a parameter value that satisfies a selection criterion based on the target performance and the target parameter from these combinations. Assume in this embodiment that the selection criterion is that the performance value is the parameter value closest to the target parameter among the parameter values satisfying the target performance.

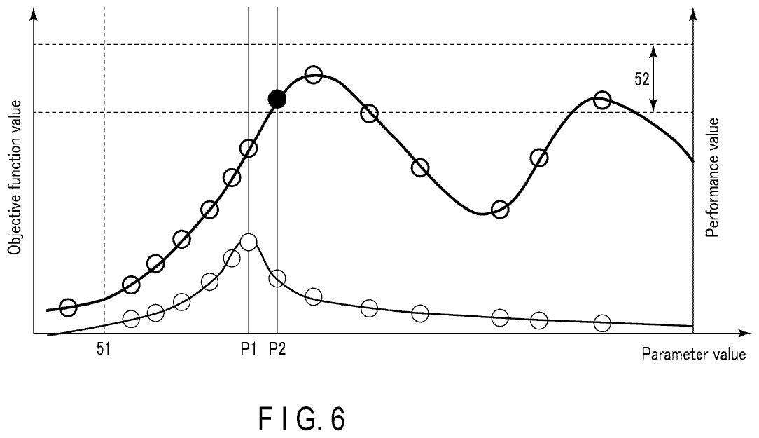

FIG. 6 is a diagram schematically showing an example of output parameter selection made by the selection unit 105. In FIG. 6, the left vertical axis represents the objective function value, the right vertical axis represents the performance value, and the horizontal axis represents the parameter value. The thick line represents the true function of the performance value regarding the parameter value, and the thin line represents the true function of the objective function value regarding the parameter value. The circles indicate parameter values supplied to the external device 20 by the calculation unit 103, performance values acquired from the external device 20 regarding the parameter values, and objective function values calculated from the acquired performance values. A target parameter 51 is set for the parameter values, and a performance specification 52, which is the target performance specified as a range, is set for the performance values.

In the example shown in FIG. 6, in the comparative example in which an output parameter value is searched based only on the objective function value, the performance value does not satisfy the performance specification 52 because the parameter value P1 for which the objective function value is maximized is set as the output parameter value. In the present embodiment, the performance value satisfies the performance specification 52 because the parameter P2 in which the performance value is closest to the target parameter 51 among the parameter values satisfying the performance specification 52 is selected as the output parameter value.

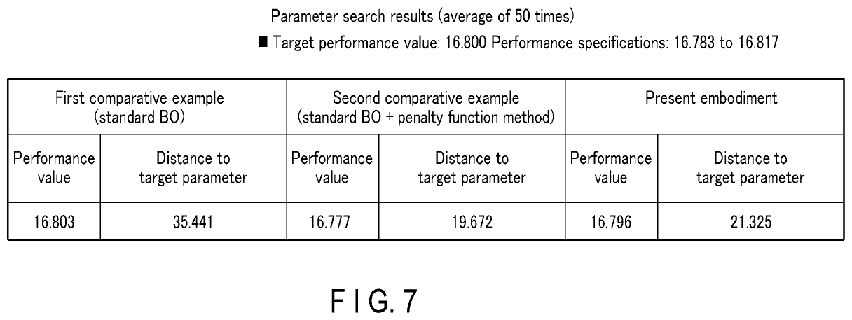

FIG. 7 is a table showing parameter search results of a first comparative example (standard Bayesian optimization which will be referred to as standard BO hereinafter), a second comparative example (standard BO+penalty function method) and the present embodiment. The standard BO is a method in which a first function f(x) for evaluating the parameter value x based on the performance value in the equation (1) is used as the objective function to search for a parameter value that maximizes the objective function value of the objective function. The first comparative example employed the standard BO. The penalty function method is a method for using an objective function to which a constraint term is added. The second comparison example employed a method in which the penalty function method is combined with the standard BO, that is, a method for searching for a parameter value that maximizes the objective function value of an objective function to which a penalty term is added. As described above, the present embodiment is directed to a method in which a selection method for selecting a parameter value whose performance value is closest to the target parameter among the parameter values satisfying the target performance is combined with the standard BO+penalty function method. The target performance value (target performance for specifying a scalar value) is 16.800, and the performance specifications (target performance for specifying a range) is 16.783 to 16.817. The target parameters were set to values where each of the parameter values constituting the target parameter was zero.

As shown in FIG. 7, in the first comparative example, the performance value is close to the target performance value, but the output parameter value cannot be brought close to the target parameter. In the second comparison example, the output parameter value can be brought close to the target parameter, but the performance value may not satisfy the performance specifications as in the example because the objective function value is changed by a penalty amount. In the present embodiment, the output parameter value can be brought close to the target parameter while the performance value satisfies the performance specifications.

If step S110 is executed, the parameter search process according to the present embodiment ends.

The parameter search process shown in FIG. 5 is an example, and the present embodiment is not limited thereto, but a variety of processes can be added, deleted and/or changed as long as they do not deviate from the spirit of the invention.

As an example, the parameter search apparatus 10 according to the foregoing embodiment includes a first storage unit 101 that stores a combination of parameter values and objective function values and a second storage unit 104 that stores a combination of parameter values and performance values, but the present embodiment is not limited thereto. For example, the parameter search apparatus 10 may include a storage unit that stores a combination of parameter values, objective function values and performance values. As another example, the parameter search apparatus 10 may include a storage unit that stores both a combination of parameter values and objective function values, and a combination of parameter values and performance values.

As another example, the output parameter value selected in step S110 may be displayed in a predetermined layout by the display control unit 109. In this case, the display control unit 109 may display only the output parameter value or a combination of the output parameter values, performance values and objective function values. The output parameter value and the like may be displayed numerically or graphically as shown in FIG. 6. If it is displayed by the graph shown in FIG. 6, the display control unit 109 may display the target parameters, the performance specifications and the like together with the output parameter values and the like.

Assume in the foregoing embodiment that the objective function f′(x) is the sum of the first function f(x) and the second function g(x) with weighting factor w, as seen from the above equation (1). However, the present embodiment is not limited thereto. As another example, the objective function f′(x) may be the sum of f(x) and g(x) with weighting factor w.

Assume in the foregoing embodiment that as an example of a parameter value satisfying the selection criterion, the selection unit 105 selects a parameter value closest to the target parameter value among the parameter values whose performance values satisfy the target performance value. However, the present embodiment is not limited thereto. As another example, the selection unit 105 may select, as a parameter value satisfying the selection criterion, a parameter value whose performance value is closest to the target performance value among parameter values satisfying the target parameter value. In this case, the target parameter value may be specified as a range and the performance value may be specified as a scalar value. If the selection criterion is thus designed, a parameter value that satisfies the target parameter value can be selected in comparison with the above embodiment. The selection criterion should be designed according to the user's request.

### Application Example

Next is a description of a parameter adjustment system according to an application example of the present embodiment. In the following example, components having substantially the same function as that of the above embodiment will be denoted by the same reference symbol, and their overlapping descriptions will be given only when necessary.

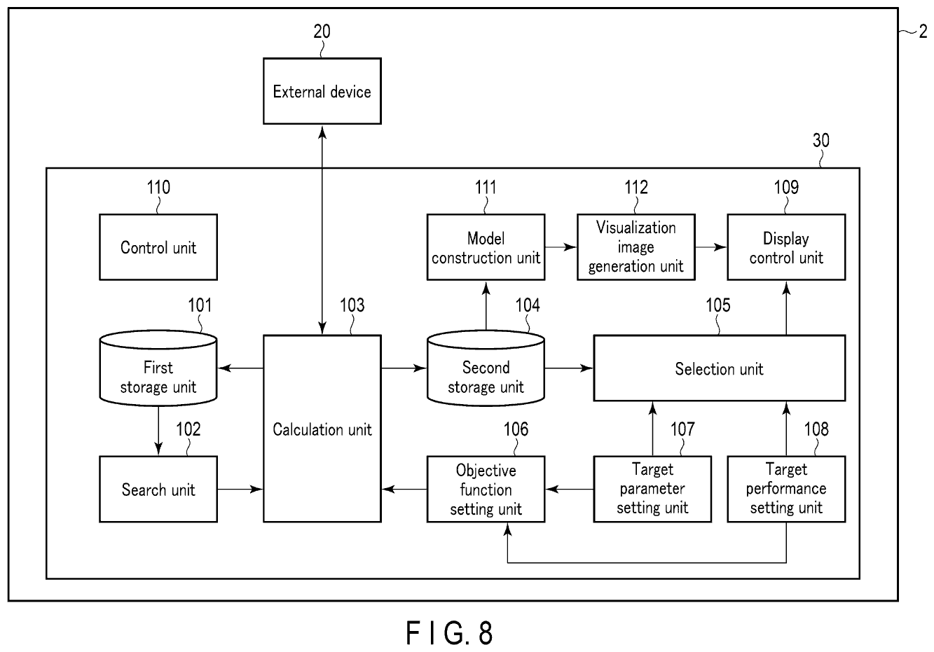

FIG. 8 is a block diagram showing an example of a functional configuration of a parameter adjustment system 2 according to the application example. As shown in FIG. 8, the parameter adjustment system 2 includes a parameter search apparatus 30 and an external device 20. The parameter search apparatus 30 is a computer that search for an optimum parameter value. The parameter search apparatus 30 includes a first storage unit 101, a search unit 102, a calculation unit 103, a second storage unit 104, a selection unit 105, an objective function setting unit 106, a target parameter setting unit 107, a target performance setting unit 108, a display control unit 109 and a control unit 110, a model construction unit 111 and a visualization image generation unit 112.

Based on a combination of a parameter value and a performance value stored in the second storage unit 104, the model construction unit 111 constructs a second model that infers a performance value from the parameter value.

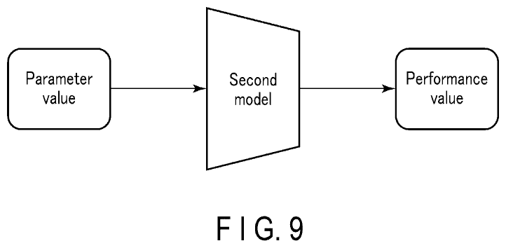

FIG. 9 is a diagram showing the relationship between input and output of a second model. The model construction unit 111 uses a combination of the parameter value stored in the second storage unit 104 and its corresponding performance value as training data to train the second model based on a training method such as Gaussian process regression, a random forest and a neural network. Thus, the second model is constructed with the parameter value as input and the performance value as output.

The visualization image generation unit 112 generates an image which visualizes the correspondence between the parameter value and the performance value (referred to as a visualization image hereinafter) based on the second model constructed by the model construction unit 111. For example, the visualization image generation unit 112 inputs a set of parameter values to the second model to calculate a set of performance values and generate a visualization image based on the set of parameter values and the set of performance values. The visualization image may be displayed on the display device by the display control unit 109.

Using the second model, the parameter search apparatus 30 can predict a performance value corresponding to the parameter value without using the external device 20. Since the visualization image is generated based on the second model, the user can easily grasp the correspondence between the parameter values and the performance values. The visualization image may be displayed observably from outside the parameter search apparatus 30.

### (Hardware Configuration)

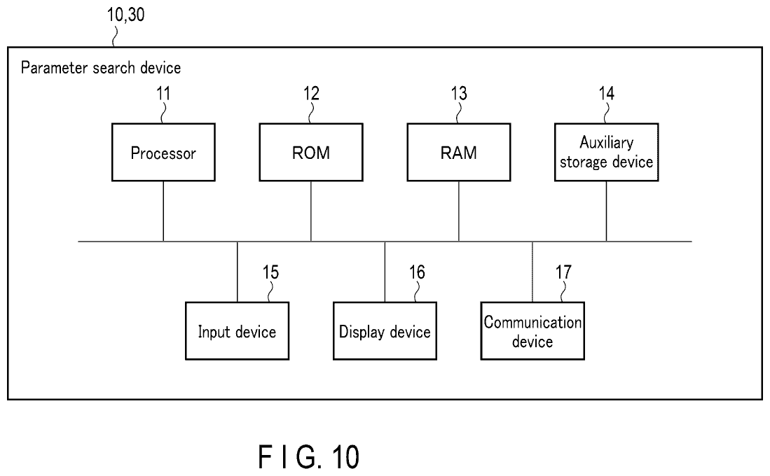

FIG. 10 is a block diagram showing an example of a hardware configuration of the parameter search apparatus 10 or 30. As shown in FIG. 10, the parameter search apparatus 10 or 30 is a computer including a processor 11, a read only memory (ROM) 12, a random access memory (RAM) 13, an auxiliary storage device 14, an input device 15, a display device 16 and a communication device 17. Data and various signals are transmitted and received between the processor 11, ROM 12, RAM 13, auxiliary storage device 14, input device 15, display device 16 and communication device 17 via a bus.

The processor 11 is an integrated circuit that controls the entire operation of the parameter search apparatus 10 or 30. The processor 11 includes, for example, a central processing unit (CPU), a graphics processing unit (GPU), a digital signal processor (DSP) and/or a floating-point unit (FPU). The processor 11 may include an internal memory and an I/O interface. The processor 11 interprets and executes programs stored in advance in the ROM 12, the auxiliary storage device 14 or the like to perform a variety of processes of the foregoing embodiment. Note that the processor 11 may be implemented partly or wholly by hardware such as an application specific integrated circuit (ASIC) and a field programmable gate array (FPGA).

The ROM 12 is a nonvolatile memory that stores a variety of items of data. For example, the ROM 12 stores data, setting values and the like used by the processor 11 when performing various processes. The ROM 12 may include a non-transitory computer readable storage medium that stores programs to be executed by the processor 11.

The RAM 13 is a volatile memory for use in reading and writing data. The RAM 13 temporarily stores data to be used when the processor 11 performs various processes. The RAM 13 provides a work area for the processor 11.

The auxiliary storage device 14 is a nonvolatile memory that stores a variety of items of data. For example, the auxiliary storage device 14 stores data and setting values used when the processor 11 performs various processes, data generated by the various processes in the processor 11, and the like. The auxiliary storage device 14 is configured by a hard disk drive (HDD), a solid state drive (SSD), an integrated circuit storage device, or the like. Note that the auxiliary storage device 14 may include a non-transitory computer-readable storage medium that stores programs to be executed by the processor 11.

The input device 15 receives input of a variety of operations from an operator. As the input device 15, a keyboard, a mouse, various switches, a touch pad, a touch panel display, and the like can be used. The processor 11 is supplied with an electrical signal (referred to as an operation signal hereinafter) in response to the received input.

The display device 16 displays a variety of items of data under the control of the processor 11. As the display device 16, a cathode-ray tube (CRT) display, a liquid crystal display, an organic electroluminescent (EL) display, a light-emitting diode (LED) display, a plasma display, or any other display may be used as appropriate. The display device 16 may be a projector.

The communication device 17 includes a communication interface such as a network interface card (NIC) for performing data communications between a variety of devices connected to the parameter search apparatus 10 or 30 via a network. Note that an operation signal may be supplied from a computer connected via the communication device 17 or an input device included in the computer, or a variety of items of data may be displayed on a display device or the like included in a computer connected via the communication device 17. The input device 15 can be replaced with a computer connected via the communication device 17 or an input device included in the computer, and the display device 16 can be replaced with a display device or the like included in a computer connected via the communication device 17.

The parameter search apparatus 10 or 30 need not include some of the processor 11, ROM 12, RAM 13, auxiliary storage device 14, input device 15, display device 16 and communication device 17. The parameter search apparatus 10 or 30 may be provided with any additional hardware equipment that is useful for performing the process according to the present embodiment. The parameter search apparatus 10 or 30 need not be physically configured by a single computer, but may be configured by a computer system including a plurality of computers communicatively connected by wire or via a network line or the like. The assignment of a series of processes according to the present embodiment to a plurality of processors 11 mounted on their respective computers can optionally be set. All of the processors 11 may perform all of the processes in parallel. Alternatively, one or some of the processors 11 may be assigned a specific process, and the computer system as a whole may perform a series of processes according to the present embodiment.

The present embodiment can thus provide a parameter search apparatus, a method and a program capable of selecting a parameter value that is appropriate from the viewpoint of both a parameter value and a performance value.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parameter search apparatus comprising a processing circuit which:
sets a target parameter representing a target of a parameter value;
sets target performance representing a target of a performance value;
sets an objective function based on a first function that evaluates the parameter value based on the performance value and a second function that evaluates the parameter value based on the target parameter;
calculates a first objective function value by applying to the objective function a first performance value corresponding to a first parameter value to be evaluated or both the first parameter value and the first performance value;
stores the first objective function value in a first memory in association with the first parameter value;
stores the first performance value in a second memory in association with the first parameter value;
constructs a first model representing the objective function based on a combination of the first parameter value and the first objective function value which are stored in the first memory and determines a first parameter value to be evaluated next based on the first model; and
selects a first parameter value that satisfies a selection criterion based on the target performance and the target parameter from the first parameter value stored in the second memory.

2. The parameter search apparatus of claim 1, wherein the processing circuit selects, as a first parameter value that satisfies the selection criterion, a first parameter value closest to the target parameter from among first parameter values in which the first performance value satisfies the target performance.

3. The parameter search apparatus of claim 1, wherein the target parameter is given by one of a scalar value, a range and a function.

4. The parameter search apparatus of claim 1, wherein the target performance is given by one of a scalar value, a range and a function.

5. The parameter search apparatus of claim 1, wherein as the target performance, one or more target performances are given.

6. The parameter search apparatus of claim 1, wherein the first function evaluates the first parameter value higher as the first performance value is higher.

7. The parameter search apparatus of claim 1, wherein the first function is defined based on one or more performance values.

8. The parameter search apparatus of claim 1, wherein the second function evaluates a distance between the first parameter value and the target parameter.

9. The parameter search apparatus of claim 1, wherein the second function gives a larger penalty as the first parameter value is farther from the target parameter.

10. The parameter search apparatus of claim 1, wherein the objective function is a weighted sum of the first function and the second function.

11. The parameter search apparatus of claim 1, wherein the processing circuit supplies the first parameter value to an external device and acquires, as the first performance value, a performance value in response to the first parameter value supplied to the external device.

12. The parameter search apparatus of claim 1, wherein the first model is based on one of Gaussian process regression, a random forest and a neural network.

13. The parameter search apparatus of claim 1, wherein the processing circuit constructs a second model which infers a second performance value from the second parameter value based on a combination of the first parameter value and the first performance value which are stored in the second memory.

14. The parameter search apparatus of claim 13, wherein the processing circuit:
generates an image which visualizes a correspondence between the second parameter value and the second performance value based on the second model; and
displays the image on a display device.

15. The parameter search apparatus of claim 1, wherein the processing circuit displays the selected first parameter value on a display device.

16. A parameter search method comprising:
setting a target parameter representing a target of a parameter value;
setting target performance representing a target of a performance value;
setting an objective function based on a first function that evaluates the parameter value based on the performance value and a second function that evaluates the parameter value based on the target parameter;
calculating a first objective function value by applying to the objective function a first performance value corresponding to a first parameter value to be evaluated or both the first parameter value and the first performance value;
storing the first objective function value in a first memory in association with the first parameter value;
storing the first performance value in a second memory in association with the first parameter value;
constructing a first model representing the objective function based on a combination of the first parameter value and the first objective function value which are stored in the first memory and determining a first parameter value to be evaluated next based on the first model; and
selecting a first parameter value that satisfies a selection criterion based on the target performance and the target parameter from the first parameter value stored in the second memory.

17. A non-transitory computer readable medium including computer executable instructions, wherein the instructions, when executed by a processor, cause the processor to perform operations comprising:
setting a target parameter representing a target of a parameter value;
setting target performance representing a target of a performance value;
setting an objective function based on a first function that evaluates the parameter value based on the performance value and a second function that evaluates the parameter value based on the target parameter;
calculating a first objective function value by applying to the objective function a first performance value corresponding to a first parameter value to be evaluated or both the first parameter value and the first performance value;
storing the first objective function value in a first memory in association with the first parameter value;
storing the first performance value in a second memory in association with the first parameter value;
constructing a first model representing the objective function based on a combination of the first parameter value and the first objective function value which are stored in the first memory and determining a first parameter value to be evaluated next based on the first model; and
selecting a first parameter value that satisfies a selection criterion based on the target performance and the target parameter from the first parameter value stored in the second memory.
